(19) United States
(12) Patent Application Publication
(10) Pub. No.: US 2011/0006886 A1
(43) Pub. Date: Jan. 13, 2011

(54) WIRELESS SWITCH TRIGGERING BLACK BOX SYSTEM FOR A VEHICLE AND CONTROL METHOD THEREOF

(75) Inventor: Min Woo PARK, Seongnam-si (KR)

Correspondence Address: MCDERMOTT WILL & EMERY LLP, 600 13TH STREET, N.W., WASHINGTON, DC, 20005-3096, US

(73) Assignee: MANDO CORPORATION

(21) Appl. No.: 12/832,585

(22) Filed: Jul. 8, 2010

(30) Foreign Application Priority Data
Jul. 8, 2009 (KR) 10-2009-0061984

(51) Int. Cl. H04Q 5/22

(52) U.S. Cl. 340/10.5

(57) ABSTRACT

Disclosed is a black box system for a vehicle and a control method thereof. The wireless switch triggering black box system includes: a black box terminal comprising an acceleration sensor, a camera module, a data storage unit, and a wireless transmission module; and a wireless reception module, which transmits an operation trigger signal for the data storage unit to the wireless transmission module when an embedded switch of the wireless reception module is operated, wherein the data storage unit included in the black box terminal stores data acquired during a predetermined time interval before and after the operation of the switch. In the wireless switch triggering black box system, a wireless transmission module for triggering the data storage of a black box terminal is located at a position at which a driver can easily handle the wireless transmission module, so that the driver can trigger the execution of black box function without losing the driver's front visual field at a time point desired by the driver, thereby securing a safe driving environment.

### BACKGROUND OF THE INVENTION

1. Field of the Invention

The present invention relates to a black box system for a vehicle and a control method thereof. In particular, the present invention relates to a wireless switch triggering black box system for a vehicle and a control method thereof, in which a wireless transmission module for triggering the data storage of a black box terminal is located at a position at which a driver can easily handle the wireless transmission module, so that the driver can trigger the execution of □ black box function without losing the driver's front visual field at a time point desired by the driver, thereby securing a safe driving environment.

2. Description of the Prior Art

In general, a representative black box includes a flight recorder for recording the performance and the condition of an airplane in flight. However, the black box system is recently being employed in not only the airplanes but also in vehicles, such as an automobile.

The black box system stores a record of information including the driving condition of a vehicle, the situation of an accident, etc. Therefore, if a car accident has occurred, it is possible to make an objective determination about the accident based on the record stored in the black box.

A black box system for a vehicle includes an acceleration sensor for detecting a speed of the vehicle and an external impact, a camera for shooting the front of the vehicle (in some cases, including a camera for shooting the backside of the vehicle), and a storage unit for storing the driving information of the vehicle.

The black box has a video signal processing unit for controlling the input and output of the video signals from cameras and encoding and decoding the input and output video signals and a storage unit for storing the driving situation shot by the cameras during a preset time based on the current time point, which are embedded within the black box.

The storage unit repeatedly performs a temporary storage and a deletion of the driving state of the vehicle with a predetermined interval under normal circumstances, and especially stores the driving states before and after an accident by a signal from an impact sensor in the case of the occurrence of an accident.

Usually, the cameras are installed at the upper end of a dashboard panel displaying various data, including the speed of the vehicle, or in the rearview mirror, and the rearview camera may be installed in a subsidiary luggage compartment arranged behind the back seats of the vehicle or at the upper end of an inside brake light.

In the conventional black box system for a vehicle as described above, the acceleration sensor can detect a measured value above a predetermined level, but cannot detect a minute contact accident and cannot automatically store the driving information in the case of the minute contact accident.

Further, even in the case of the conventional black box system additionally having the manual operation function, which enables the driver to manually store the driving information, since the switch for the manual operation is installed within the black box terminal, the driver may fail in securing his or her front visual field when he or she tries to operate the switch, which may cause a severe safety problem, such as a car accident.

### SUMMARY OF THE INVENTION

Accordingly, the present invention has been made to solve the above-mentioned problems occurring in the prior art, and an object of the present invention is to provide a black box system for a vehicle and a control method thereof, in which a wireless transmission module for triggering the data storage of a black box terminal is located at a position at which a driver can easily handle the wireless transmission module, so that the driver can trigger the execution of black box function without losing the driver's front visual field at a time point desired by the driver, thereby securing a safe driving environment.

In order to accomplish this object, there is provided a wireless switch triggering black box system for a vehicle, the wireless switch triggering black box system comprising: a black box terminal comprising an acceleration sensor, a camera module, a data storage unit, and a wireless transmission module; and a wireless reception module, which transmits an operation trigger signal for the data storage unit to the wireless transmission module when an embedded switch of the wireless reception module is operated, wherein the data storage unit included in the black box terminal stores data acquired during a predetermined time interval before and after the operation of the switch.

In accordance with another aspect of the present invention, there is provided a method of controlling a wireless switch triggering black box system for a vehicle, the method comprising: an acceleration comparison/determination step for comparing a preset value and a value measured by a acceleration sensor; a switch operation determination step for determining if a wireless transmission module has received an operation trigger signal; and a data storage step for storing data during a predetermined time interval before and after a time point of the determination, when it is determined in the acceleration comparison/determination step that the value measured by the acceleration sensor is larger than the preset value or when it is determined in the switch operation determination step that the operation trigger signal has been received.

In a wireless switch triggering black box system for a vehicle and a control method thereof according to an embodiment of the present invention as described above, a wireless transmission module for triggering the data storage of a black box terminal is located at a position at which a driver can easily handle the wireless transmission module, so that the driver can trigger the execution of black box function without losing the driver's front visual field at a time point desired by the driver, thereby securing a safe driving environment.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram illustrating the structure of a wireless switch triggering black box system for a vehicle according to an embodiment of the present invention;

FIG. 2 is a perspective view of a part within a vehicle at which a wireless switch triggering black box system for a vehicle according to an embodiment of the present invention is installed; and

FIG. 3 is a flowchart illustrating a control method of a wireless switch triggering black box system for a vehicle according to an embodiment of the present invention.

### DETAILED DESCRIPTION OF THE EXEMPLARY EMBODIMENTS

Hereinafter, exemplary embodiments of the present invention will be described with reference to the accompanying drawings. In the following description and drawings, the same reference numerals are used to designate the same or similar components, and so repetition of the description on the same or similar components will be omitted. Further, in the following description of the present invention, a detailed description of known functions and configurations incorporated herein will be omitted when it may make the subject matter of the present invention rather unclear.

In addition, terms, such as first, second, A, B, (a), (b) or the like may be used herein when describing components of the present invention. Each of these terminologies is not used to define an essence, order or sequence of a corresponding component but used merely to distinguish the corresponding component from other component(s). It should be noted that if it is described in the specification that one component is “connected,” “coupled” or “joined” to another component, a third component may be “connected,” “coupled,” and “joined” between the first and second components, although the first component may be directly connected, assembled or joined to the second component.

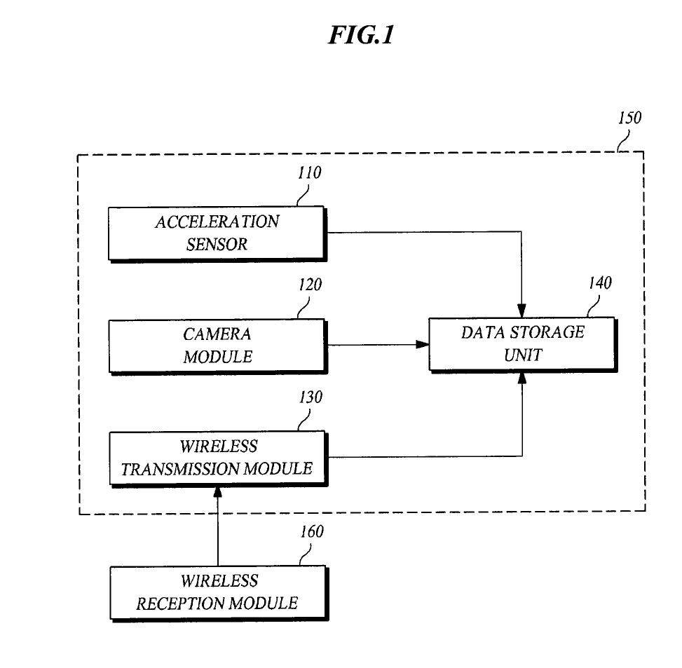

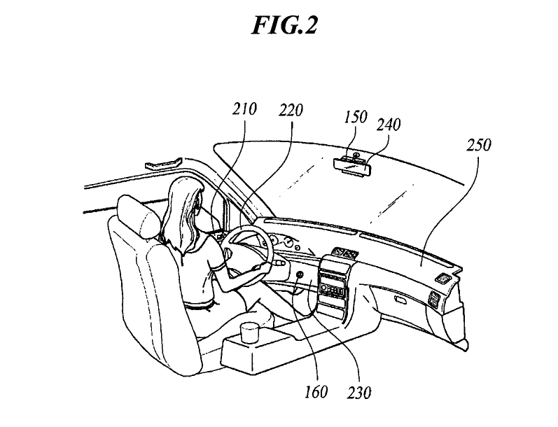

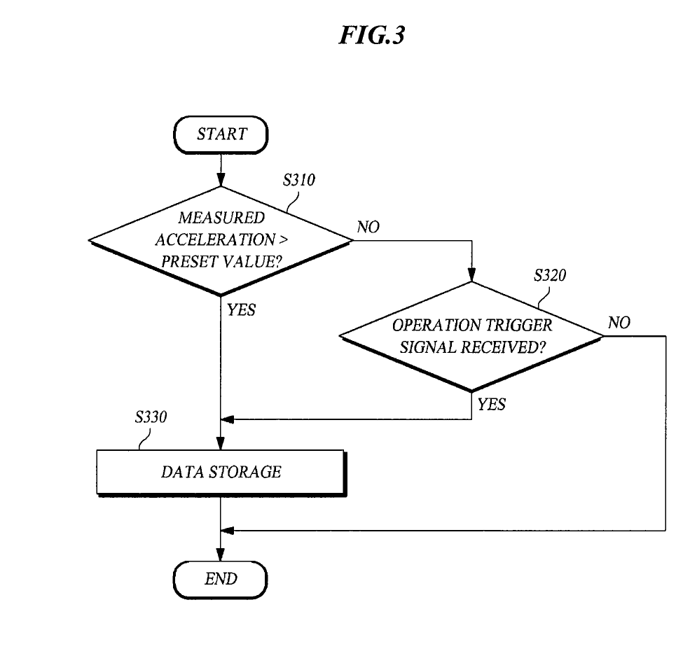

FIG. 1 is a block diagram illustrating the structure of a wireless switch triggering black box system for a vehicle according to an embodiment of the present invention, FIG. 2 is a perspective view of a part within a vehicle at which a wireless switch triggering black box system for a vehicle according to an embodiment of the present invention is installed, and FIG. 3 is a flowchart illustrating a control method of a wireless switch triggering black box system for a vehicle according to an embodiment of the present invention.

As shown in FIGS. 1 and 2, a wireless switch triggering black box system for a vehicle according to an embodiment of the present invention includes: a black box terminal 150, which is installed on a dashboard 250, a rearview mirror 240, or the ceiling of a vehicle and includes an acceleration sensor 110, a camera module 120, a data storage unit 140, and a wireless transmission module 130; and a wireless reception module 160, which is installed at a steering wheel 220, a crash pad 230, or a driver side door 210 of the vehicle and transmits an operation trigger signal of the data storage unit 140 to the wireless transmission module 130 when an embedded switch is operated. When a driver operates a switch of the wireless reception module 160, the data storage unit 140 stores images shot during a predetermined time interval before and after the operation of the switch.

As in a typical black box system, in the wireless switch triggering black box system for a vehicle according to an embodiment of the present invention also, the data storage unit 140 of the black box terminal 150 temporarily stores measured values of various sensors and the images shot by the camera module 120 while deleting the temporarily stored data sequentially from the older data. Further, if the driver intentionally operates the switch of the wireless reception module 160 at the time of driving through an accident prone area or at the time of a light contact accident, the black box terminal 150 stores data during a predetermined time interval before and after the operation of the switch.

In brief, the wireless switch triggering black box system for a vehicle according to an embodiment of the present invention includes a black box terminal 150, and a wireless reception module 160 for triggering data storage at a particular time point according to the driver's intention.

The black box terminal 150 includes an acceleration sensor 110 for measuring a variance in the speed of the vehicle, a camera module 120 for shooting surrounding images, a data storage unit 140 for storing measured values of various sensors and image data; and a wireless transmission module 130 for receiving an operation trigger signal generated when the driver operates the switch of the wireless reception module 160, which are embedded in the black box terminal 150. The black box terminal 150 is installed in a dashboard 250, a rearview mirror 240, or the ceiling of the vehicle, in order to secure the driver's visual fields around the vehicle.

The wireless reception module 160 is installed in a steering wheel 220, a crash pad 230, or a driver side door 210 of the vehicle, which are located within an area which both arms of the driver can easily reach, and the driver can safely operate the switch of the wireless reception module 160 without losing the driver's front visual field during the driving.

The wireless reception module 160 has an embedded switch for triggering a signal transmission to the wireless transmission module 130. When a driver operates the switch, the wireless reception module 160 transmits an operation trigger signal for the data storage unit 140, the wireless transmission module 130 of the black box terminal 150 receives the operation trigger signal, and the data storage unit 140 stores data during a predetermined time before and after the operation trigger signal is transmitted.

The wireless transmission of the operation trigger signal between the wireless reception module 160 and the wireless transmission module 130 may be based on the Radio Frequency Identification (RFID) scheme. At this time, each of the wireless reception module 160 and the wireless transmission module 130 may have an embedded RFID tag and an embedded RFID reader. Besides the RFID scheme, any wireless transmission/reception scheme, such as Bluetooth or LAN, capable of wirelessly transmitting the operation trigger signal can be employed for the wireless transmission of the operation trigger signal.

The operation trigger signal may include wireless transmission module identification number information for identifying the wireless reception module 160, data storage unit operation indication information for indicating the operation of the data storage unit 140, etc., by which the operation trigger signal can be exactly delivered to the wireless transmission module 130 without confusion with another wireless transmission unit.

The wireless transmission module identification number information as described above may be stored in the wireless reception module 160 and registered in the black box terminal 150. In this case, the black box terminal 150 identifies the wireless transmission module identification number information and the data storage unit operation indication information included in the operation trigger signal received through the wireless transmission module 130, and determines if the wireless transmission module identification number information has been already registered in the black box terminal 150. As a result of the determination, when the wireless transmission module identification number information has been already registered in the black box terminal 150, the data storage unit 140 may store data during a predetermined time interval before and after the operation of the switch by the driver, by using the data storage unit operation indication information.

Meanwhile, the operation trigger signal described above may further include checksum information for detection and correction of an error, which may be included in the wireless transmission module identification number information and the data storage unit operation indication information. Then, by using the checksum information, the black box terminal 150 can examine if the operation trigger signal received through the wireless transmission module 130 includes an error. When detecting an error, the black box terminal 150 can correct the error, and then perform the functions using the signal. As a result, it is possible to achieve an exact delivery of the signal information included in the operation trigger signal and an execution of exact functions based on the signal information.

Meanwhile, as shown in FIG. 3, a control method of a wireless switch triggering black box system for a vehicle according to an embodiment of the present invention includes: an acceleration comparison/determination step (S310) for comparing a preset value and a value measured by the acceleration sensor 110; a switch operation determination step (S320) for determining if the wireless transmission module 130 has received an operation trigger signal; and a data storage step (S330) for storing data during a predetermined time interval before and after a time point of the determination when it is determined in the acceleration comparison/determination step (S310) that the value measured by the acceleration sensor 110 is larger than the preset value or when it is determined in the switch operation determination step (S320) that the operation trigger signal has been received.

In a general case, as in a typical black box system for a vehicle, the data storage unit 140 embedded in the black box terminal 150 temporarily stores measured values of various sensors and the images shot by the camera module 120 while deleting the temporarily stored data sequentially from the older data.

At this time, if it is determined that the measured value continuously input from the acceleration sensor 110 is larger than the preset value, that is, if a large measured acceleration value, such as that due to a collision of a car, is input, data obtained during a predetermined time interval before and after the time point of the determination that the measured value is larger than the preset value in the acceleration comparison/determination step (S310) is stored.

Further, if it is determined that the measured value continuously input from the acceleration sensor 110 is larger than the preset value, that is, in the case of a light contact accident which the acceleration sensor 110 cannot detect, or if the driver intentionally operates the switch of the wireless reception module 160 in preparation for driving through an accident prone area, etc., data obtained during a predetermined time interval before and after the time point of the determination that the operation trigger signal has been received in the switch operation determination step (S320) is stored.

Therefore, instantly when the driver presses the switch of the wireless reception module 160, the wireless reception module 160 transmits the operation trigger signal, and the wireless transmission module 130 then receives the operation trigger signal. Then, the data is stored in the data storage step (S330), so that the data can be used as a useful resource.

In a wireless switch triggering black box system for a vehicle and a control method thereof according to an embodiment of the present invention as described above, a wireless transmission module for triggering the data storage of a black box terminal is located at a position at which a driver can easily handle the wireless transmission module, so that the driver can trigger the execution of black box function without losing the driver's front visual field at a time point desired by the driver, thereby securing a safe driving environment.

Even though it was described above that all of the components of an embodiment of the present invention are coupled as a single unit or coupled and operated as a single unit, the present invention is not limited to such an embodiment. That is, within the purpose of the present invention, all of the components may be selectively coupled and operated as one or more units.

In addition, since terms, such as “comprising,” “including,” and “having” mean that one or more corresponding components may exist unless they are specifically described to the contrary, it shall be construed that one or more other components can be included. All of the terminologies containing one or more technical or scientific terminologies have the same meanings that persons skilled in the art understand ordinarily unless they are defined otherwise. A term ordinarily used like that defined by a dictionary shall be construed that it has a meaning equal to that in the context of a related description, and shall not be construed in an ideal or excessively formal meaning unless it is clearly defined in the present specification.

Although exemplary embodiments of the present invention have been described for illustrative purposes, those skilled in the art will appreciate that various modifications, additions and substitutions are possible, without departing from the scope and spirit of the invention as disclosed in the accompanying claims. Therefore, the embodiment disclosed in the present invention is intended to illustrate the scope of the technical idea of the present invention, and the scope of the present invention is not limited by the embodiment. The scope of the present invention shall be construed on the basis of the accompanying claims, and it shall be construed that all of the technical ideas included within the scope equivalent to the claims belong to the present invention.

What is claimed is:

1. A wireless switch triggering black box system for a vehicle, the wireless switch triggering black box system comprising:
a black box terminal comprising an acceleration sensor, a camera module, a data storage unit, and a wireless transmission module; and
a wireless reception module, which transmits an operation trigger signal for the data storage unit to the wireless transmission module when an embedded switch of the wireless reception module is operated,
wherein the data storage unit included in the black box terminal stores data acquired during a predetermined time interval before and after the operation of the switch.

2. The wireless switch triggering black box system of claim 1, wherein the wireless transmission module transmits the operation trigger signal to the wireless transmission module having an embedded Radio Frequency Identification (RFID) tag and an embedded RFID reader.

3. The wireless switch triggering black box system of claim 1, wherein the operation trigger signal comprises wireless transmission module identification number information for identifying the wireless reception module and data storage unit operation indication information for indicating an operation of the data storage unit.

4. The wireless switch triggering black box system of claim 3, wherein the wireless transmission module identification number information has been stored in the wireless transmission module and has been registered in the black box terminal, and the black box terminal identifies the wireless transmission module identification number information and the data storage unit operation indication information included in the operation trigger signal received through the wireless transmission module, determines if the wireless transmission module identification number information has been already registered in the black box terminal, and, as a result of the determination, when the wireless transmission module identification number information has been already registered in the black box terminal, controls the data storage unit so that the data storage unit stores data during a predetermined time interval before and after the operation of the switch, by using the data storage unit operation indication information.

5. The wireless switch triggering black box system of claim 1, wherein the operation trigger signal further comprises checksum information for detection and correction of an error, which may be included in the wireless transmission module identification number information and the data storage unit operation indication information.

6. The wireless switch triggering black box system of claim 1, wherein the black box terminal is installed on a dashboard, a rearview mirror, or a ceiling of a vehicle, and the wireless reception module is installed at a steering wheel, a crash pad, or a driver side door of the vehicle.

7. A method of controlling the wireless switch triggering black box system for a vehicle according to one of claims 1 to 6, the method comprising:
an acceleration comparison/determination step for comparing a preset value and a value measured by a acceleration sensor;
a switch operation determination step for determining if a wireless transmission module has received an operation trigger signal; and
a data storage step for storing data during a predetermined time interval before and after a time point of the determination, when it is determined in the acceleration comparison/determination step that the value measured by the acceleration sensor is larger than the preset value or when it is determined in the switch operation determination step that the operation trigger signal has been received.
